(19) United States
(12) Patent Application Publication
(10) Pub. No.: US 2019/0375447 A1
(43) Pub. Date: Dec. 12, 2019

(54) SYSTEMS FOR STEERING WHEEL ROTATION CONTROL

(71) Applicant: GM GLOBAL TECHNOLOGY OPERATIONS LLC, Detroit, MI (US)

(72) Inventors: John T. Zuzelski, Clarkston, MI (US); Scott R. Kloess, Rochester Hills, MI (US); Josh M. Tavel, Grosse Pointe Woods, MI (US)

(21) Appl. No.: 16/001,106

(22) Filed: Jun. 6, 2018

(51) Int. Cl. B62D 5/04

(52) U.S. Cl. CPC B62D 5/046; B62D 5/0409

(57) ABSTRACT

An exemplary method for controlling a vehicle steering system includes providing a vehicle sensor configured to measure a vehicle characteristic, providing at least one controller in communication with the vehicle sensor and the vehicle steering system, receiving, by the controller, sensor data from the vehicle sensor indicative of the vehicle characteristic, determining, by the controller, a steering system condition from the sensor data, and generating and transmitting, by the controller, a control signal to the steering system based on the determined steering system condition.

### INTRODUCTION

The present invention relates generally to the field of vehicles and, more specifically, to steering wheels and steering columns for motor vehicles.

Steering wheel rotation can be locked to prevent vehicle theft, for example. Steering wheel rotation lock has typically been executed by the use of a separate mechanical and/or electrical module attached to the steering column. However, recent improvements in theft prevention technology have resulted in removal of this module, allowing the steering wheel to freely rotate during operator entry into and egress from the vehicle.

### SUMMARY

Embodiments according to the present disclosure provide a number of advantages. For example, embodiments according to the present disclosure enable the use of existing sensors to determine when the operator is entering or exiting the vehicle and, if one of those conditions are met, turning on or enabling the electronic power steering system (EPS system) to lock the steering wheel or hold the steering wheel rigid (non-rotating) during operator entry into and egress from the vehicle.

In one aspect, a method for controlling a vehicle steering system includes the following steps. The vehicle steering system includes a rotatable shaft, a rotatable steering wheel coupled to the rotatable shaft, and a motor coupled to the rotatable shaft and the method includes the steps of providing a vehicle sensor configured to measure a vehicle characteristic, providing at least one controller in communication with the vehicle sensor and the vehicle steering system, receiving, by the controller, sensor data from the vehicle sensor indicative of the vehicle characteristic, determining, by the controller, a steering system condition from the sensor data, and generating and transmitting, by the controller, a control signal to the steering system based on the determined steering system condition.

In some aspects, the vehicle characteristic includes one or more of an ignition status, a vehicle door switch status, a vehicle door lock status, a transmission gear position, and a vehicle speed.

In some aspects, the steering system condition is a steering wheel rotation lock condition.

In some aspects, determining the steering system condition includes analyzing the sensor data to determine if a first condition is satisfied.

In some aspects, the first condition includes one of an operator entry status and an operator egress status.

In some aspects, if the first condition is satisfied, the control signal enables the steering system.

In some aspects, enabling the steering system further includes generating, by the controller, a motor control signal.

In some aspects, the motor control signal instructs the motor to prevent rotation of the rotatable shaft.

In another aspect, an automotive vehicle includes a body, a plurality of vehicle wheels coupled to the body, a steering system coupled to the body and to the plurality of wheels, the steering system including a rotatable shaft, a rotatable steering wheel coupled to the rotatable shaft, and a motor coupled to the rotatable shaft, a vehicle sensor configured to measure a vehicle characteristic, and at least one controller in communication with the vehicle sensor and the vehicle steering system. The controller is configured to receive sensor data from the vehicle sensor indicative of the vehicle characteristic, determine a steering system condition from the sensor data, and generate a motor control signal based on the determined steering system condition.

In some aspects, the vehicle characteristic includes one or more of an ignition status, a vehicle door switch status, a vehicle door lock status, a transmission gear position, and a vehicle speed.

In some aspects, the steering system condition is a steering wheel rotation lock condition.

In some aspects, determining the steering system condition includes analyzing the sensor data to determine if a first condition is satisfied.

In some aspects, the first condition includes one of an operator entry status and an operator egress status.

In some aspects, if the first condition is satisfied and the vehicle speed is zero, the motor control signal instructs the motor to hold the rotatable shaft in a non-rotating position.

In yet another aspect, a system for controlling vehicle steering includes a steering system including a rotatable shaft, a rotatable steering wheel coupled to the rotatable shaft, and a motor, a vehicle sensor configured to measure a vehicle characteristic, and at least one controller in communication with the vehicle sensor and the vehicle steering system. The controller is configured to receive sensor data from the vehicle sensor indicative of the vehicle characteristic, determine a steering system condition from the sensor data, and generate a motor control signal based on the determined steering system condition.

In some aspects, the vehicle characteristic includes one or more of an ignition status, a vehicle door switch status, a vehicle door lock status, a transmission gear position, and a vehicle speed.

In some aspects, the steering system condition is a steering wheel rotation lock condition.

In some aspects, determining the steering system condition includes analyzing the sensor data to determine if a first condition is satisfied.

In some aspects, the first condition includes one of an operator entry status and an operator egress status.

In some aspects, if the first condition is satisfied and the vehicle speed is zero, the motor control signal instructs the motor to hold the rotatable shaft in a non-rotating position.

### BRIEF DESCRIPTION OF THE DRAWINGS

The present disclosure will be described in conjunction with the following figures, wherein like numerals denote like elements.

FIG. 1 is a functional block diagram of a vehicle that includes, among other features, a steering system in accordance with exemplary embodiments.

FIG. 2 is a block diagram of a vehicle control system and vehicle steering system, according to an embodiment.

FIG. 3 is a flowchart of a method for controlling a vehicle, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Some vehicle architectures make it difficult for an operator to enter and exit the vehicle without an assist member, such as a handle. Preventing rotation of the steering wheel can improve operator entry into and egress from a vehicle by, for example, providing a stable point for the operator to grip or hold. Embodiments discussed herein utilize the electronic power steering system (EPS system), existing vehicle sensors, and a vehicle control system to hold the steering wheel rigid when conditions are detected indicating that the operator is either entering into or exiting from the vehicle.

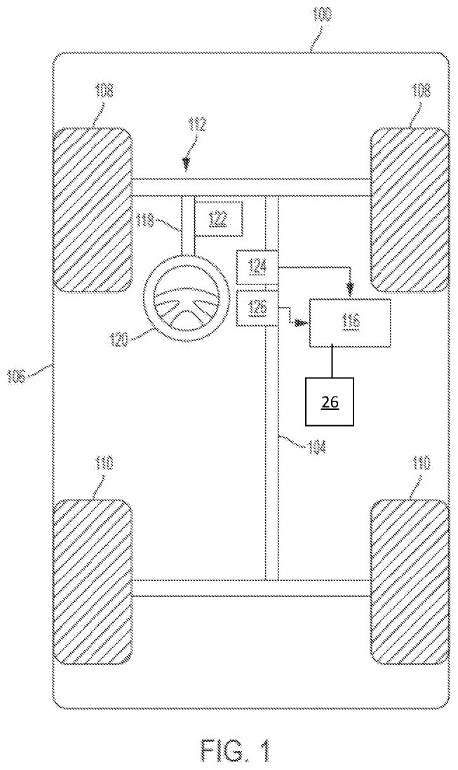

With reference to FIG. 1, a vehicle 100 is shown that includes a steering system 112 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 100 generally includes a chassis 104, a body 106, front wheels 108, rear wheels 110, a steering system 112, and a control system 116. The body 106 is arranged on the chassis 104 and substantially encloses the other components of the vehicle 100. The body 106 and the chassis 104 may jointly form a frame. The wheels 108-110 are each rotationally coupled to the chassis 104 near a respective corner of the body 106.

As can be appreciated, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

In some embodiments, the steering system 112 includes a steering column assembly 118 and a steering wheel 120. In various embodiments, the steering system 112 is an electronic power steering (EPS) system. In various embodiments, the steering system 112 is a rack EPS system. In various embodiments, the steering system 112 is a column EPS system.

In various embodiments, the steering system 112 includes a motor 122 that is coupled to the steering system 112, and that provides torque or force to one or more of the wheels 108-110. In some embodiments, such as a column EPS system, the motor 122 can be coupled to the rotatable shaft of the steering column assembly 118. In some embodiments, the motor 122 can prevent rotation of the rotatable shaft of the steering column assembly 118 and by preventing rotation of the shaft, also prevent rotation of a steering wheel 120. In some embodiments, such as a rack EPS system, the motor 122 can be coupled to the rack of the steering system 112 and similarly prevent rotation of the rotatable shaft of the steering column assembly and thereby prevent rotation of the steering wheel 120.

The steering system 112 further includes one or more sensors that sense observable conditions of the steering system 112. In various embodiments, the steering system 112 includes a torque sensor 124 and a position sensor 126. The torque sensor 124 senses a rotational torque applied to the steering system by for example, a driver of the vehicle 100 via the steering wheel 120 and generates torque signals based thereon. The position sensor 126 senses a rotational position of the steering wheel 120 and generates position signals based thereon.

With further reference to FIG. 1, the vehicle 100 also includes a plurality of sensors 26 configured to measure and capture data on one or more vehicle characteristics, including but not limited to vehicle speed, vehicle heading, throttle position, ignition status, vehicle door open/close status, etc. In the illustrated embodiment, the sensors 26 include, but are not limited to, an accelerometer, a position sensor, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, pressures sensors, contact sensors, and/or additional sensors as appropriate.

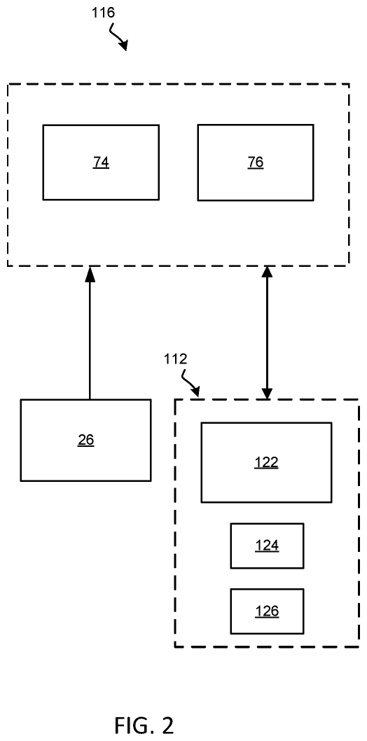

FIG. 2 is a block diagram of the control system 116. The control system 116 receives sensor data from one or more sensors and monitors operation of the steering system 112 based thereon. In some embodiments, the control system 116 is organized by function or module. For example, as shown in FIG. 2, the control system 116 can include a sensor fusion module 74 and a steering wheel rotation lock module 76. In some embodiments, the control system 116 further includes at least one timer.

In some embodiments, the sensor fusion module 74 receives and processes one or more data signals from one or more of the sensors 26 indicating an observable condition or characteristic of the vehicle. These conditions include, for example and without limitation, a vehicle speed, a transmission gear position, a vehicle ignition status, a vehicle door switch status, whether a key is in the ignition, and/or a vehicle door lock status. In some embodiments, the sensor fusion module 74 synthesizes the sensor data and predicts one or more operating conditions of the vehicle 100. In some embodiments, the predicted operating condition indicates whether an operator is exiting from or entering the vehicle 100.

The processed sensor data generated by the sensor fusion module 74 is received by the steering wheel rotation lock module 76. In some embodiments, the steering wheel rotation lock module 76 analyzes the sensor data and generates a control signal to enable the steering system 112 if the sensor data indicates that the operator is entering or exiting the vehicle 100. The control signal is transmitted to the steering system 112. As discussed herein, the steering system 112 is an EPS system.

In some embodiments, for example and without limitation, the control system 116 controls the steering system 112 to remain engaged after the ignition is turned off or the key is removed from the ignition such that the motor 122 holds the rotatable shaft of the steering column assembly 118 and the steering wheel 120 in a non-rotating position by resisting the motion of the steering wheel 120 and allowing the operator to use the steering wheel to assist with egress from the vehicle.

In some embodiments, for example and without limitation, the control system 116 enables the steering system 112 prior to key on (for example, when an unlock signal is received or the operator's door is opened) such that the motor 122 holds the rotatable shaft of the steering column assembly 118 and the steering wheel 120 in a non-rotating position to allow the operator to use the steering wheel to assist with entry into the vehicle. In other embodiments, other signals, such as, for example and without limitation, a transmission gear position, a door switch sensor, a key fob proximity signal, a door lock/unlock signal, etc., are analyzed by the control system 116 to determine whether engage the steering system 112 to hold the steering wheel in a rigid, or non-rotating, position. In some embodiments, a vehicle controller, such as a controller of the control system 116 or a vehicle engine control unit (ECU) wakeup signal is used to initiate the steering wheel lock condition if certain vehicle criteria are met, either individually or in combination. These criteria include, for example and without limitation, the vehicle in park, door open, and/or vehicle speed is zero. In some embodiments, a timing limit is used to prevent battery rundown or extended usage of the steering wheel lock feature. In some embodiments, implementation of the steering wheel lock feature is limited to specific circumstances for safety reasons.

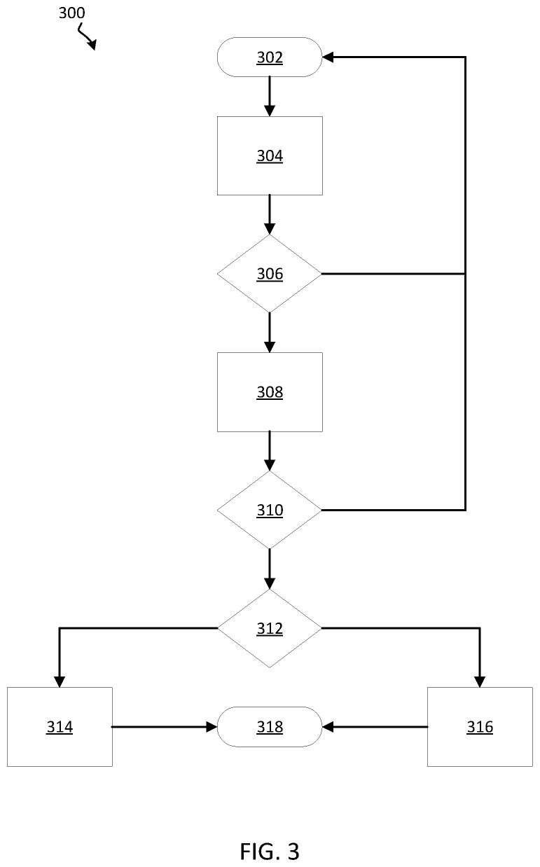

FIG. 3 illustrates a method 300 to control a vehicle, specifically a steering system of a vehicle. The method 300 can be utilized in connection with the steering system 112, the sensors 26, the steering column assembly 118, the steering wheel 120, and the control system 116 of the vehicle 100, as shown in FIGS. 1 and 2. The method 300 can be utilized in connection with the modules of the control system 116 as discussed herein, or by other systems associated with or separate from the vehicle, in accordance with exemplary embodiments. The order of operation of the method 300 is not limited to the sequential execution as illustrated in FIG. 3, but may be performed in one or more varying orders, or steps may be performed simultaneously, as applicable in accordance with the present disclosure.

The method 300 begins at 302 and proceeds to 304. At 304, the control system 116 receives sensor data from one or more of the vehicle sensors 26. The sensor data is indicative of a vehicle characteristic. In some embodiments, the vehicle characteristic indicates whether the operator is getting into or exiting from the vehicle. In some embodiments, for example and without limitation, the vehicle characteristic includes one or more of a transmission gear position, a door open or close status, a key fob proximity, a door lock/unlock status, an ignition status, a vehicle key on/key off status, and a zero vehicle speed condition.

Next, at 306, the control system 116 determines a steering system condition from the sensor data. In some embodiments, determining the steering system condition includes determining whether the sensor data indicates that a first condition is satisfied. In some embodiments, the first condition is satisfied if the operator is entering or exiting the vehicle and the vehicle speed is zero. In some embodiments, the sensor data is processed and analyzed by the sensor fusion module 74. In some embodiments, the steering system condition is a steering wheel rotation lock condition.

If the determination at 306 is negative, that is, the first condition is not satisfied because the sensor data does not indicate that the operator is entering into or exiting from the vehicle, the method 300 returns to 302 and proceeds as discussed herein.

If the first condition is satisfied, that is, the sensor data indicates that the operator is entering or exiting the vehicle (for example and without limitation, the transmission gear is in park, the operator's door is open, the vehicle is in a key off state, the ignition is off, and/or the vehicle speed is zero), the method 300 proceeds to 308. At 308, the control system 116 generates a control signal to enable the steering system 112 and initiates a timer. In some embodiments, such as when the sensor data indicates that the operator is entering or exiting the vehicle, the control signal instructs the steering system 112 to remain enabled for a specified time interval. For the duration of the time interval, the steering system 112 remains enabled such that the motor 122 holds the steering shaft and the steering wheel 120 in a non-rotating position.

From 308, the method 300 proceeds to 310. At 310, the control system 116 determines whether the specified time interval, as measured by the timer initiated at 308, has elapsed. If the specified time interval has elapsed, the method 300 proceeds to 312. At 312, the control system 116 determines whether the steering system 112 should remain enabled and return to normal operation, that is, allow the steering wheel 120 to rotate, or if the steering system 112 should be disabled. The steering system 112 remains enabled when the operating conditions indicate that the operator will be driving the vehicle and the steering system 112 returns to normal operation. The steering system 112 is disabled when the operating conditions indicate that the operator has exited the vehicle.

If the operating conditions indicate that the steering system 112 should remain initiated, the method 300 proceeds to 314 for operation of the steering system 112 by the control system 116 according to normal vehicle operating conditions. The method 300 then proceeds to 318 and ends.

If the operating conditions indicate that the steering system 112 should be disabled, the method 300 proceeds to 316. At 316, the control system 116 disables the steering system 112 and the method then proceeds to 318 and ends.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fail within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an, and “the” include plural referents unless the context clearly dictates otherwise. Thus, for example, reference to an item includes reference to one or more items. The term “ones” refers to one, two, or more, and generally applies to the selection of some or all of a quantity. The term plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for controlling a vehicle steering system comprising a rotatable shaft, a rotatable steering wheel coupled to the rotatable shaft, and a motor coupled to the rotatable shaft, the method comprising:
providing a vehicle sensor configured to measure a vehicle characteristic;
providing at least one controller in communication with the vehicle sensor and the vehicle steering system;
receiving, by the controller, sensor data from the vehicle sensor indicative of the vehicle characteristic;
determining, by the controller, a steering system condition from the sensor data; and
generating and transmitting, by the controller, a control signal to the steering system based on the determined steering system condition.

2. The method of claim 1, wherein the vehicle characteristic includes one or more of an ignition status, a vehicle door switch status, a vehicle door lock status, a transmission gear position, and a vehicle speed.

3. The method of claim 1, wherein the steering system condition is a steering wheel rotation lock condition.

4. The method of claim 1, wherein determining the steering system condition comprises analyzing the sensor data to determine if a first condition is satisfied.

5. The method of claim 4, wherein the first condition includes one of an operator entry status and an operator egress status.

6. The method of claim 5, wherein if the first condition is satisfied, the control signal enables the steering system.

7. The method of claim 6, wherein enabling the steering system further comprises generating, by the controller, a motor control signal.

8. The method of claim 7, wherein the motor control signal instructs the motor to prevent rotation of the rotatable shaft.

9. An automotive vehicle, comprising:
a body;
a plurality of vehicle wheels coupled to the body;
a steering system coupled to the body and to the plurality of wheels, the steering system including a rotatable shaft, a rotatable steering wheel coupled to the rotatable shaft, and a motor coupled to the rotatable shaft;
a vehicle sensor configured to measure a vehicle characteristic;
at least one controller in communication with the vehicle sensor and the vehicle steering system, the controller configured to
receive sensor data from the vehicle sensor indicative of the vehicle characteristic;
determine a steering system condition from the sensor data; and
generate a motor control signal based on the determined steering system condition.

10. The automotive vehicle of claim 9, wherein the vehicle characteristic includes one or more of an ignition status, a vehicle door switch status, a vehicle door lock status, a transmission gear position, and a vehicle speed.

11. The automotive vehicle of claim 10, wherein the steering system condition is a steering wheel rotation lock condition.

12. The automotive vehicle of claim 11, wherein determining the steering system condition comprises analyzing the sensor data to determine if a first condition is satisfied.

13. The automotive vehicle of claim 12, wherein the first condition includes one of an operator entry status and an operator egress status.

14. The automotive vehicle of claim 13, wherein if the first condition is satisfied and the vehicle speed is zero, the motor control signal instructs the motor to hold the rotatable shaft in a non-rotating position.

15. A system for controlling vehicle steering, the system comprising:
a steering system including a rotatable shaft, a rotatable steering wheel coupled to the rotatable shaft, and a motor;
a vehicle sensor configured to measure a vehicle characteristic;
at least one controller in communication with the vehicle sensor and the vehicle steering system, the controller configured to
receive sensor data from the vehicle sensor indicative of the vehicle characteristic;
determine a steering system condition from the sensor data; and
generate a motor control signal based on the determined steering system condition.

16. The system of claim 15, wherein the vehicle characteristic includes one or more of an ignition status, a vehicle door switch status, a vehicle door lock status, a transmission gear position, and a vehicle speed.

17. The system of claim 16, wherein the steering system condition is a steering wheel rotation lock condition.

18. The system of claim 17, wherein determining the steering system condition comprises analyzing the sensor data to determine if a first condition is satisfied.

19. The system of claim 18, wherein the first condition includes one of an operator entry status and an operator egress status.

20. The system of claim 19, wherein if the first condition is satisfied and the vehicle speed is zero, the motor control signal instructs the motor to hold the rotatable shaft in a non-rotating position.
